(19) United States
(12) Patent Application Publication
(10) Pub. No.: US 2005/0185533 A1
(43) Pub. Date: Aug. 25, 2005

(54) Actuator, optical pickup device, and optical disk apparatus

(76) Inventor: Akihiro Tanaka, Kanagawa (JP)

Correspondence Address: DICKSTEIN SHAPIRO MORIN & OSHINSKY LLP, 2101 L Street, NW, Washington, DC, 20037, US

(21) Appl. No.: 11/062,829

(22) Filed: Feb. 23, 2005

(30) Foreign Application Priority Data
Feb. 23, 2004 (JP) 2004-046365

(51) Int. Cl. G11B 7/085

(52) U.S. Cl. 369/44.22; 369/44.15; 720/683; 720/685

(57) ABSTRACT

Optical disk apparatus technology is disclosed for preventing the generation of media tilt even when thrust forces generated by focusing coils of an actuator may vary, and accurately driving an objective lens. A pair of focusing coils is arranged such that one focusing coil is fixed at one side of a lens supporting member and the other focusing coil is fixed at the other side of the lens supporting member with respect to a tangential direction of a track formed on an optical disk. The positioning of the focusing coils is arranged such that if one focusing coil is rotated around an optical axis of the objective lens by 180 degrees, the position of this focusing coil coincides with the position of the other focusing coil.

### BACKGROUND OF THE INVENTION

1. Field of the Invention

The present invention relates generally to an actuator, an optical pickup device, and an optical disk apparatus, and particularly to an actuator for driving an objective lens of an optical pickup device, an optical pickup device implementing such as actuator, and an optical disk apparatus implementing such an optical pickup device.

2. Description of the Related Art

In recent years and continuing, with the dramatic development of digital technology and improvement in the performance of information processing apparatuses such as personal computers (referred to as PC hereinafter) and video apparatuses, the amount of information (amount of data) being handled by such information processing apparatuses is rapidly increasing. In turn, attention is being directed to optical disks that are capable of recording large amounts of data. For example, the CD (Compact Disc), and the DVD (Digital Versatile Disc), which corresponds to a disk having the same diameter as the CD and is capable of recording approximately seven times the amount of data that may be recorded on a CD, are becoming widespread with the decrease in their prices. Also, optical disk apparatuses that correspond to drive apparatuses for accessing such optical disks are becoming increasingly popular.

In an optical disk apparatus, information recording and erasing may be realized by irradiating a laser on a recording surface of an optical disk on which surface a spiral track or concentric tracks may be formed, and recorded information may be reproduced based on light reflected from the recording surface. The optical disk apparatus includes an optical pickup device that is arranged to form an optical spot by irradiating the laser on the recording surface and receive light reflected from the recording surface.

Generally, an optical pickup device includes an objective lens, an optical system that guides a light flux irradiated from a light source to the recording surface of the optical disk and guides reflected light from the recording surface to a predetermined light receiving position, an optical detector that is positioned at the light receiving position, and a lens drive unit (actuator) that drives the objective lens in its optical axis direction (referred to as ‘focus direction’ hereinafter) or in an orthogonal direction with respect to a tangential direction of the track(s) (referred to as ‘tracking direction’ hereinafter), for example. The optical detector is arranged to output reproducing information of data recorded on the recording surface as well as information for controlling the position of the objective lens (servo information).

In the optical disk apparatus, a focus error signal and a track error signal are detected from a signal including the servo information from the optical detector, and in a case where focus deviation is detected in the optical spot, the objective lens is shifted in the focus direction by the lens drive unit (actuator) to correct the focus deviation (focus control). In a case where track deviation is detected in the optical spot, the objective lens is shifted in the tracking direction by the lens drive unit (actuator) to correct the track deviation (tracking control).

However, in shifting the objective lens, torque may be generated due to a variation in the drive force (thrust) in the lens driving unit, and as a result, deviations may occur in the optical axis direction of the objective lens and in a direction perpendicular to the recording surface (the deviations also being referred to as ‘media tilts’). It is noted that media tilt with respect to the tangential direction of the track is referred to as tangential tilt, and a media tilt with respect to a direction perpendicular to the tangential direction of the track is referred to as radial tilt.

With the growing demand for increased recording capacity in the optical disk, various measures are being taken to achieve a higher recording density in the optical recording disk. To achieve a higher recording density, the spot diameter of the optical spot formed on the recording layer has to be reduced. To this end, an objective lens with a large numerical aperture may be used. However, as the numerical aperture of the objective lens increases, a tolerance range for media tilts becomes smaller so that the quality of the signal output from the optical detector may be degraded.

In response to such a problem, a technique for preventing the generation of media tilts occurring from focus control and tracking control has been developed in the prior art (e.g. Japanese Laid-Open Patent Publication No. 2001-34974). However, the objective lens driving unit disclosed in Japanese Laid-Open Patent Publication No. 2001-34974 may not be able to adapt to further miniaturization and cost reduction requirements that are expected to be demanded in the future.

### SUMMARY OF THE INVENTION

The present invention has been conceived in response to the one or more problems of the related art, and its first object is to provide an actuator that is capable of accurately driving an objective lens without enlargement or cost increase.

Also, it is a second object of the present invention to provide an optical pickup device that is capable of forming an accurately-shaped optical spot.

Also, it is a third object of the present invention to provide an optical disk apparatus that is capable of accurately and stably conducting an information accessing operation on an optical disk.

According to an aspect of the present invention, an actuator is provided that is configured to drive an objective lens that condenses light on a recording surface of an optical disk having a spiral track or concentric tracks formed thereon, the actuator including:
a pair of focusing coils, the positioning of which focusing coils is arranged such that if a first focusing coil of the focusing coils is rotated by 180 degrees around an optical axis of the objective lens, the resulting position of the first focusing coil after the rotation substantially coincides with the position of a second focusing coil of the focusing coils, the pair of focusing coils being configured to generate a thrust force in a direction along the optical axis of the objective lens according to a current supplied thereto; and
a lens supporting member that supports the objective lens, the first focusing coil being fixed at one side of the lens supporting member with respect to a tangential direction of the track, and the second focusing coil being fixed at the other side of the lens supporting member with respect to the tangential direction of the track.

According to an aspect of the present invention, when a current is supplied to a pair of focusing coils, thrust forces may be generated by the respective focusing coils according to the supplied current. By arranging the positioning of the focusing coils such that if one of the focusing coils is rotated 180 degrees with respect to an optical axis of an objective lens, the position of this focusing coil coincides with the other focusing coil, and the generation of a media tilt may be prevented even when there is a certain amount of variation in the thrust forces generated by the respective focusing coils. In one aspect, the objective lens may be accurately driven without requiring enlargement or cost increase.

According to a preferred embodiment, the actuator of the present invention further includes:
at least a pair of tracking coils that is fixed to the lens supporting member and is configured to generate a thrust force in a tracking direction that is perpendicular to the tangential direction of the track according to a current supplied thereto.

According to another preferred embodiment of the present invention, the first focusing coil and the second focusing coil are arranged at substantially equivalent positions with respect to the tracking direction.

According to another preferred embodiment of the present invention, the first focusing coil and the second focusing coil are positioned apart from each other by a predetermined distance with respect to the tracking direction.

According to another preferred embodiment of the present invention, the predetermined distance is less than or equal to a radius of gyration of a movable part that includes the objective lens, the lens supporting member, the first and second focusing coils, and the tracking coils.

According to another preferred embodiment of the present invention, the at least one pair of tracking coils is arranged to have a predetermined positional relation with respect to the pair of focusing coils.

According to another preferred embodiment of the present invention,
the at least one pair of tracking coils includes a first tracking coil and a second tracking coil;
the first tracking coil being positioned at one side of the first focusing coil with respect to the tracking direction, the second tracking coil being positioned at the other side of the second tracking coil with respect to the tracking direction.

According to another preferred embodiment of the present invention,
the at least one pair of tracking coils includes a first pair of tracking coils formed by a first tracking coil and a second tracking coil, and a second pair of tracking coils formed by a third tracking coil and a fourth tracking coil,
the first tracking coil being positioned at one side and the third tracking coil being positioned at the other side of the first focusing coil with respect to the tracking direction, and the fourth tracking coil being positioned at the one side and the second tracking coil being positioned at the other side of the second focusing coil with respect to the tracking direction.

According to another preferred embodiment, the actuator of the present invention further includes:
a pair of tilt coils that is fixed to the lens supporting member and is configured to generate torque that rotates around an axis corresponding to the tangential direction of the track according to a current supplied thereto.

According to another preferred embodiment of the present invention, the pair of focusing coils, the pair of tracking coils, and the pair of tilt coils are arranged to have a predetermined positional relation with respect to each other.

According to another preferred embodiment of the present invention,
the pair of tracking coils includes a first tracking coil and a second tracking coil; and
the pair of tilt coils includes a first tilt coil and a second tilt coil;
the first tracking coil being positioned at one side and the first tilt coil being positioned at the other side of the first focusing coil with respect to the tracking direction, and the second tilt coil being positioned on the one side and the second tracking coil being positioned on the other side of the second focusing coil with respect to the tracking direction.

According to another preferred embodiment of the present invention, the tilt coils are arranged to have the same configuration as the focusing coils.

According to an aspect of the present invention, an optical pickup device is provided that is configured to irradiate light on a recording surface of an optical disk having a spiral track or concentric tracks formed thereon and receive reflected light that is reflected from the recording surface, the device including:
an actuator of the present invention;
a light source that is configured to emit a light flux to be irradiated on the recording surface;
an optical system including an objective lens that is driven by the actuator and is arranged to condense the light flux from the light source onto the recording surface, the optical system being configured to guide the reflected light reflected from the recording surface to a predetermined light receiving position;
an optical detector that is positioned at the light receiving position; and
a tilt detecting unit that is configured to detect a tilting of the recording surface with respect to the objective lens.

According to an aspect of the present invention, by implementing an actuator of the present invention, an objective lens may be accurately driven and an accurately-shaped optical spot may be formed.

According to another aspect of the present invention, an optical disk apparatus is provided that is configured to conduct an information accessing operation including at least an information reproducing operation on an optical disk, the apparatus including:
an optical pickup device of the present invention; and
a processing unit that is configured to control the actuator of the optical pickup device based on an output signal of the optical pickup device and execute the information accessing operation.

According to an aspect of the present invention, an actuator of an optical pickup device of the present invention may be controlled by a processing unit based on an output signal from the optical pickup device so that the objective lens may be accurately driven and an accurately-shaped optical spot may be formed on an optical disk. In one aspect, with respect to information accessing operations on an optical disk including information recording, reproducing, and erasing, at least an information recording operation may be accurately and stably conducted.

### BRIEF DESCRIPTION OF THE DRAWINGS

FIG. 1 is a block diagram showing a configuration of an optical disk apparatus according to a first embodiment of the present invention;

FIG. 2 is a diagram showing a configuration of an optical pickup device shown in FIG.1;

FIG. 3 is a diagram showing detailed configurations of a light flux irradiating system and a detecting system shown in FIG. 2;

FIG. 4 is a diagram showing a detailed configuration of a light condensing system shown in FIG. 2;

FIG. 5 is a perspective view of the light condensing system shown in FIG. 2;

FIG. 6 is a cross-sectional view of the light condensing system shown in FIG. 4;

FIGS. 7A and 7B are diagrams illustrating the positioning of focusing coils and tracking coils of the light condensing system;

FIGS. 8A and 8B are diagrams illustrating a first permanent magnet of a pair of permanent magnets of the light condensing system;

FIGS. 9A and 9B are diagrams illustrating a second permanent magnet of the pair of permanent magnets of the light condensing system;

FIGS. 10A and 10B are diagrams illustrating the actions of the focusing coils;

FIGS. 11A and 11B are diagrams illustrating the actions of the tracking coils;

FIG. 12A and 12B are diagrams illustrating the positioning of focusing coils according to a first modified example of the first embodiment;

FIGS. 13A and 13B are diagrams illustrating the positioning of two pairs of tracking coils according to a second modified example of the first embodiment;

FIGS. 14A and 14B are diagrams showing an exemplary configuration of a first permanent magnet of a pair of permanent magnets according to the second modified example;

FIGS. 15A and 15B are diagrams showing a configuration of a second permanent magnet of the pair of permanent magnets according to the second modified example;

FIGS. 16A and 16B are diagrams illustrating the actions of the two pairs of tracking coils;

FIG. 17 is a block diagram showing a configuration of an optical pickup device according to a second embodiment of the present invention;

FIG. 18 is a perspective view of a light condensing system shown in FIG. 17;

FIG. 19 is a diagram showing an exemplary configuration of the optical pickup device according to the second embodiment that includes a tilt sensor;

FIGS. 20A and 20B are diagrams illustrating the positioning of focusing coils, tracking coils, and tilt coils according to the second embodiment; and

FIGS. 21A and 21B are diagrams illustrating the actions of the tilt coils.

### DESCRIPTION OF THE PREFERRED EMBODIMENTS

In the following, preferred embodiments of the present invention are described with reference to the accompanying drawings.

### First Embodiment

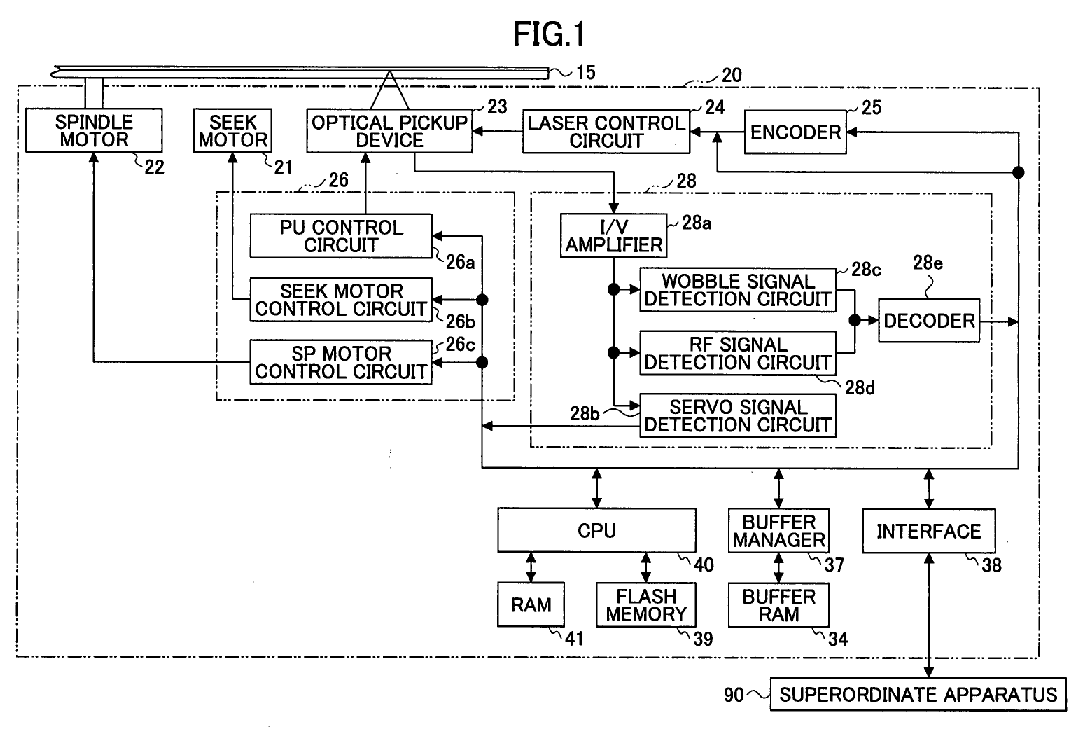

In the following, a first embodiment of the present invention is described with reference to FIGS. 1˜11B.

FIG. 1 is a block diagram showing a configuration of an optical disk apparatus according to the first embodiment.

As is shown in FIG. 1, the optical disk apparatus 20 according to the present embodiment may include a spindle motor 22 for rotating an optical disk 15, an optical pickup device 23, a seek motor 21 for driving the optical pickup device 23 in a sledge direction, a laser control circuit 24, an encoder 25, a servo control circuit 26, a reproduced signal processing circuit 28, a buffer RAM 34, a buffer manager 37, an interface 38, a flash memory 39, a CPU 40, and a RAM 41, for example. It is noted that the arrows shown in FIG. 1 indicate a representative flow of signals and information. However, these arrows do not necessarily represent all the possible connections between the elements shown in FIG. 1. In the example described below, it is assumed that an information recording medium conforming to the DVD standard is used as the optical disk 15.

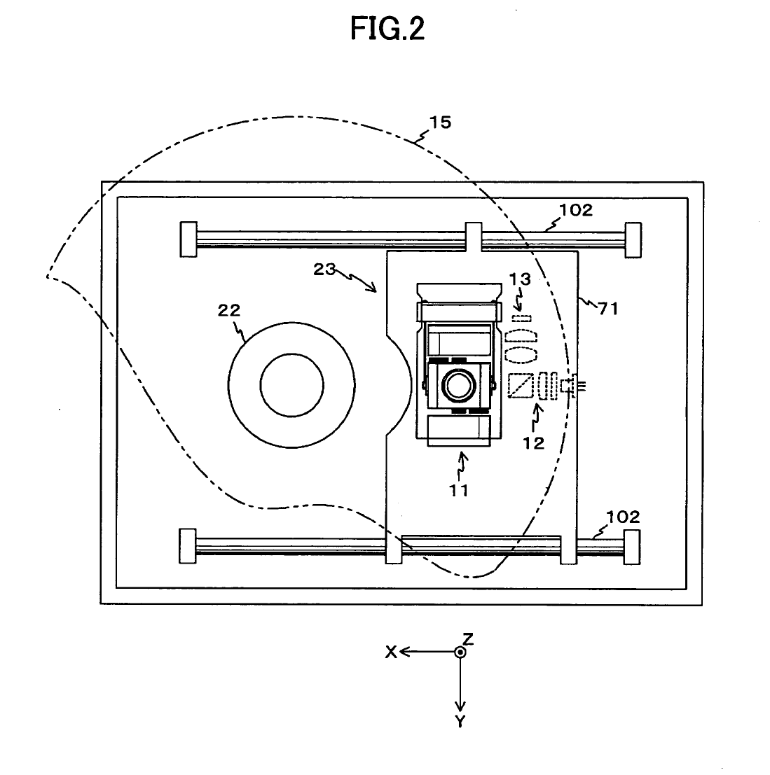

FIG. 2 is a diagram illustrating an exemplary configuration of the optical pickup device 23 of FIG. 1.

The optical pickup 23 corresponds to a device that is configured to irradiate a laser on a recording surface of the optical disk 15 having a spiral track or concentric tracks formed thereon, and receive reflected light from the recording surface. As is shown in FIG. 2, the optical pickup 23 may be supported by two seek rails 102 extending in an X-axis direction. In this example, one of the two seek rails 102 may be rotated by the seek motor 21 (not shown in FIG. 2), and a housing 71 of the optical pickup 23 may be moved in the sledge direction in response to this rotation. Also, in this example, the spindle motor 22 and the optical pickup device 23 are arranged such that the X-axis direction corresponds to the radial direction, the tracking direction (direction perpendicular to the tangential direction of the track), and the sledge direction; the Y-axis direction corresponds to the tangential direction (tangential direction of the track); and the Z-axis direction corresponds to the focus direction.

The optical pickup device shown in FIG. 2 includes a housing 71, a light flux irradiating system 12 for irradiating a light flux, a light condensing system 11 for condensing the light flux from the light flux irradiating system 12 on the recording surface of the optical disk 15, and a detecting system 13 for receiving the returning light flux from the optical disk 15. It is noted that the light flux system 12 and the detecting system 13 are accommodated within the housing 71.

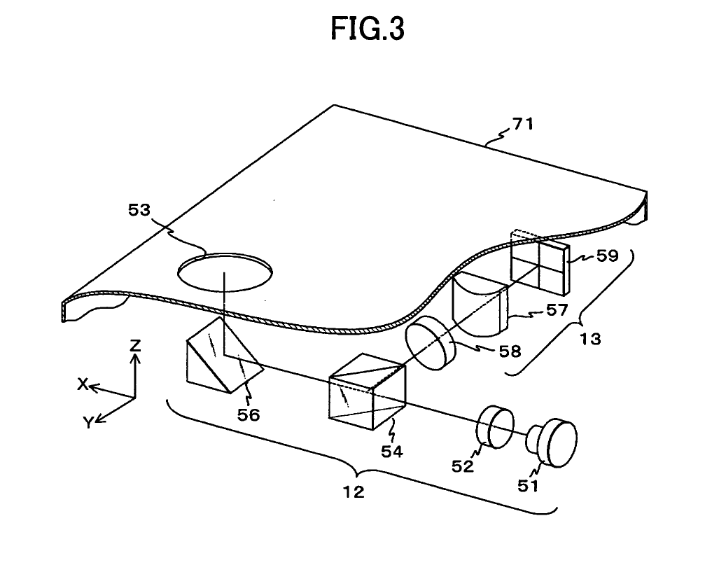

FIG. 3 is a diagram illustrating an exemplary layout of the light flux irradiating system and the detecting system of FIG. 2.

As is shown in FIG. 3, the light flux irradiating system 12 may include a light source unit 51, a collimating lens 52, a beam splitter 54, and a standup mirror 56, for example. The light source 51 may include a semiconductor laser (not shown) as a light source for irradiating a light flux with a wavelength of approximately 660 nm, for example. The light source unit 51 may be fixed to the housing 71 in a manner such that the maximum intensity irradiating direction of the light flux from the light source unit 51 may be aligned in the +X direction. The collimating lens 52 may be positioned on the +X side of the light source unit 51 and may arrange the light flux irradiated from the light source unit 51 to be approximately parallel. The beam splitter 54 may be positioned on the +X side of the collimating lens 52 and may be configured to let the light flux from the collimating lens 52 pass through. In addition, the beam splitter 54 may be arranged to divert the reflected light from the recording surface of the optical disk 15 in the −Y direction. The standup mirror 56 may be positioned at the +X side of the beam splitter 54 and may be configured to deflect the light path of the light flux passing through the beam splitter 54 in the +Z direction. The light flux deflected by the standup mirror 56 may pass through an opening 53 of the housing 71 to be incident to the condensing system 11.

According to the example of FIG. 3, the detecting system 13 may include a detection lens 58, a cylindrical lens 57, and an optical receiver 59. The detection lens 58 may be positioned at the −Y side of the beam splitter 54, and may be configured to condense the reflected light diverted in the −Y direction by the beam splitter 54. The cylindrical lens 57 may be positioned at the −Y side of the detection lens 58, and may be arranged to provide a predetermined astigmatism to the light flux condensed at the detection lens 58. The optical receiver 59 may be positioned at the −Y side of the cylindrical lens 57, and may be configured to receive the light flux from the cylindrical lens 57. The optical receiver 59 may include an optical receiving area that is divided into four parts as is the case with a conventional optical disk apparatus, and each part of the optical receiving area may be arranged to generate a signal (optical-to-electric converted signal) according to the amount of light received thereat. A signal generated at the optical receiving area may be output to the reproduced signal processing circuit 28.

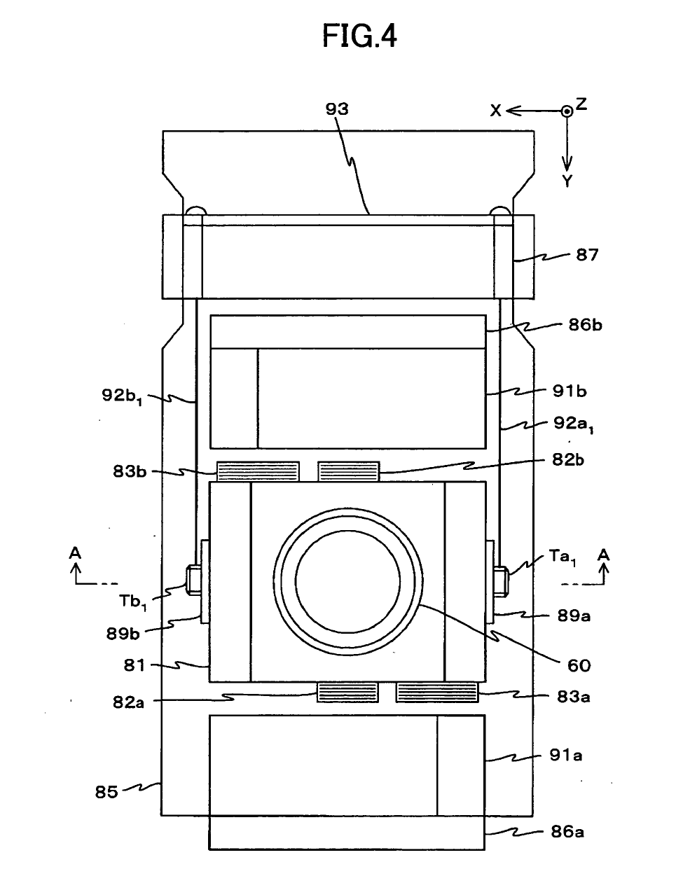

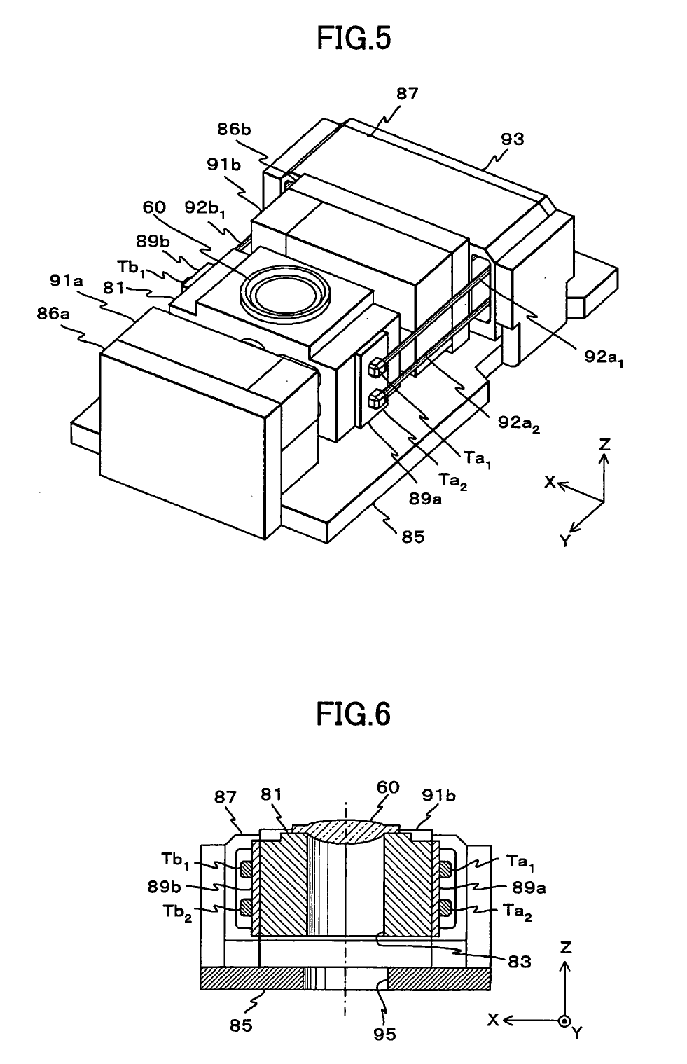

FIGS. 4˜6 illustrate an exemplary configuration of the light condensing system of FIG. 2.

As is shown in the drawings, the light condensing system 11 may include an objective lens 60, a lens holder 81 as a lens supporting member, a pair of focusing coils 82a and 82b, a pair of tracking coils 83a and 83b, a base plate 85, two yokes 86a and 86b, two permanent magnets 91a and 91b, a fixed block 87, four conductive wire springs 92a₁, 92a₂, 92b₁, and 92b₂, two movable printed circuit boards 89a and 89b, and a fixed printed circuit board 93, for example. As is described above, the optical pickup device according to the first embodiment may correspond to a so-called two-axis optical pickup.

The base plate 85 may correspond to a rectangular plate member that has an opening 95 (see FIG. 6) positioned slightly towards the +Y side from its center, the opening 95 having a shape similar to the opening 53 of the housing 71. The base plate 85 may be fixed to the housing 71 in a manner such that its longitudinal direction substantially coincides with the Y axis direction, and its opening 95 substantially coincides with the opening 53 of the housing 71. It is noted that the base plate may also function as a yoke for forming a magnetic circuit.

The yokes 86a and 86b may correspond to identical-shaped plate members that are positioned facing against each other with respect to the Y axis direction and are fixed to the base plate 85. The yoke 86a may be positioned at the +Y side of the opening 95 of the base plate 85, and the yoke 86b may positioned at the −Y side of the opening 95 of the base plate.

The fixed block 87 may be positioned at the −Y side of the yoke 86b. A through hole extending in the Y axis direction may be formed at each side edge portion of the fixed block 87 with respect to the X axis direction.

The permanent magnets 91a and 91b may correspond to identically-shaped block magnets having substantially identical magnetic characteristics. The permanent magnet 91a may be attached to the −Y side surface of the yoke 86a and the permanent magnet 91b may be attached to the +Y side surface of the yoke 86b. According to the present example, a magnetic circuit may be formed by the base plate 85, the yokes 86a and 86b, and the permanent magnets 91a and 91b, and a magnetic gap may be formed between the −Y side surface of the permanent magnet 91a and the +Y side surface of the permanent magnet 91b. It is noted that detailed descriptions of the permanent magnets are given below.

The fixed printed circuit board 93 may be fixed to the −Y side surface of the fixed block 87. The fixed printed circuit board 93 may have plural input terminals and output terminals. The input terminals may be connected to signal lines from the servo control circuit 26.

The lens holder 81 may be arranged to have an approximately cubic external structure, and may be positioned between the permanent magnet 91a and the permanent magnet 91b, namely, within the magnetic gap. According to the present example, the lens holder 81 may be positioned within the magnetic gap without being in contact with the permanent magnets 91a and 91b, and the base plate 85. Also, as is shown in FIG. 6 corresponding to a cross-sectional view of FIG. 4 cut across line A-A, the lens holder 81 may have a through hole 83 extending in the Z-axis direction, the through hole corresponding to a light path for the light flux being irradiated from the light flux irradiating system 12. The objective lens 60 may be fixed at the +Z side end of the through hole 83 in a manner such that the optical axis of the objective lens 60 substantially coincides with the central axis of the through hole 83.

The movable printed circuit board 89a may be positioned at the −X side of the lens holder 81, and the movable printed circuit board 89b may be positioned at the +X side of the lens holder 81. The movable printed circuit board 89a may have two terminals Ta₁ and Ta₂, and the movable printed circuit board 89b may have two terminals Tb₁ and Tb₂. The terminal Ta₁ may be connected to one end of the wire spring 92a₁, the terminal Ta₂ may be connected to one end of the wire spring 92a₂, the terminal Tb₁ may be connected to one end of the wire spring 92b₁, and the terminal Tb₂ may be connected to one end of the wire spring 92b₂.

According to the present embodiment, the wire springs may extend substantially along the Y-axis direction. The other ends of the wire springs may be arranged to pass through the through holes of the fixed block 87 to be connected to the output terminals of the fixed printed circuit board 93 through soldering, for example. In this way, the movable part of the light condensing system 11 may be elastically supported by the fixed block 87 through the wire springs. Also, the terminals Ta₁ and Ta₂ may be connected to the pair of focusing coils 82a and 82b, and the terminals Tb₁ and Tb₂ may be connected to the pair of tracking coils 83a and 83b. In this way, the wire springs may function as power supply media for supplying power to the focusing coils 82a and 82b, and the tracking coils 83a and 83b.

According to the present example, the pair of focusing coils 82a and 82b and the pair of tracking coils 83a and 83b may be fixed at predetermined positions of the lens holder 81. The focusing coils may be arranged to have substantially identical configurations and the tracking coils may be arranged to have substantially identical configurations. The focusing coil 82a (first focusing coil) and the tracking coil 83a (first tracking coil) may be positioned at the +Y side of the lens holder 81, and the focusing coil 82b (second focusing coil) and the tracking coil 83b (second tracking coil) may be positioned at the −Y side of the lens holder 81. It is noted that the objective lens 60, the lens holder 81, the focusing coils 82a, b, and the tracking coils 83a,b may move together as an integral part, and thereby, these components are collectively referred to as ‘moving part’ hereinafter.

The pair of focusing coils 82a and 82b may be positioned in a manner such that when one of the focusing coils (e.g., focusing coil 82a) is rotated by 180 degrees with respect to the optical axis of the objective lens 60, this focusing coil may coincide with the other focusing coil (e.g., focusing coil 82b).

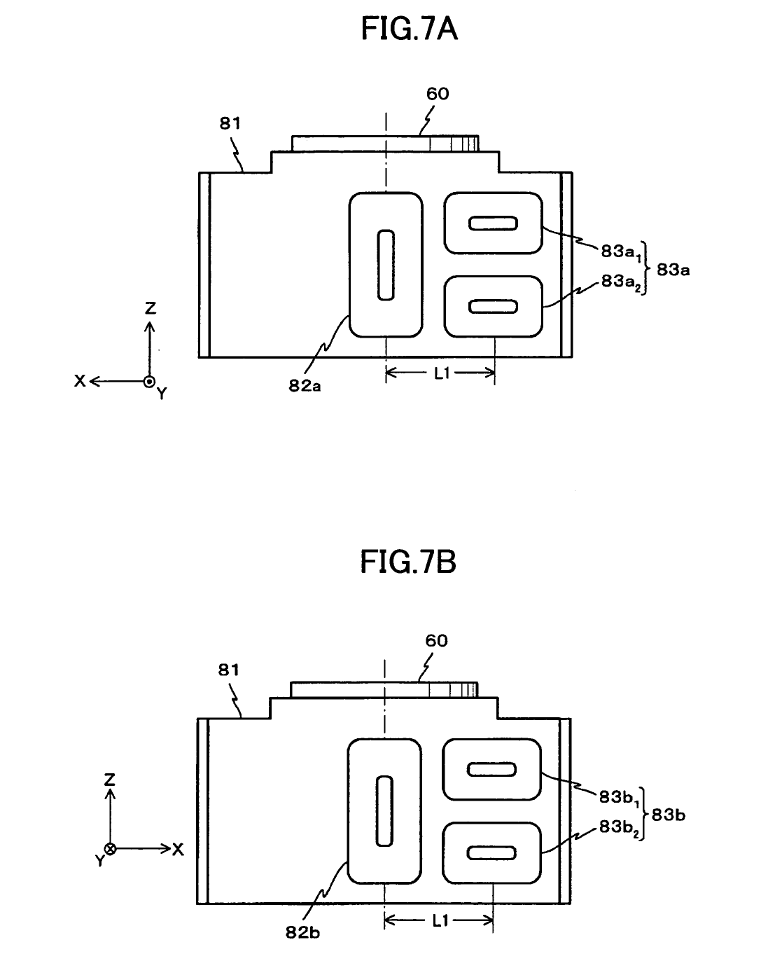

FIGS. 7A and 7B are diagrams illustrating an exemplary positioning of the focusing coils and the tracking coils.

As is shown in FIGS. 7A and 7B, the focusing coils may be positioned at approximately the same position with respect to the X axis direction. As is shown in FIG. 7A, the tracking coil 83a may be arranged to include two coils 83a₁ and 83a₂ that are positioned away from the focusing coil 82a toward the −X side by a distance of L1. As is shown in FIG. 7B, the tracking coil 83b may be arranged to include two coils 83b₁ and 83b₂ that are positioned away from the focusing coil 82b toward the +X side by the distance L1.

In the following, a detailed description of the permanent coils is given.

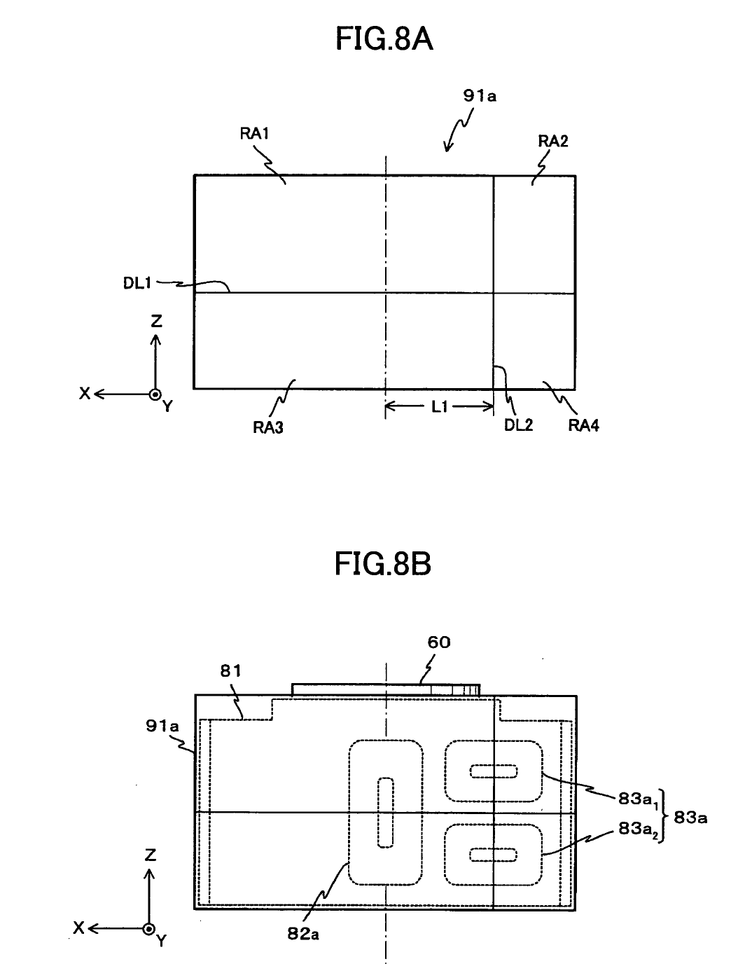

FIGS. 8A and 8B are diagrams illustrating a configuration of the permanent magnet 91a. As is shown in FIG. 8A, the permanent magnet 91a may be divided into four regions by a magnetic boundary DL1 that is parallel to the XY plane, and a magnetic boundary DL2 that is parallel to the YZ plane. As is shown in FIG. 8B, the magnetic boundary DL1 may correspond to a line that passes through the centers of the focusing coil 82a and the tracking coil 83a with respect to the Z-axis direction. The magnetic boundary DL2 may correspond to a line that passes through the center of the tracking coil 83a with respect to the X-axis direction.

In FIG. 8A, the region at the +Z side of the magnetic boundary DL1 and at the +X side of the magnetic boundary DL2 is denoted as magnetic region RA1, the region at the −X side of the magnetic region RA1 is denoted as magnetic region RA2, the region at the −Z side of the magnetic region RA1 is denoted as magnetic region RA3, and the region at the −X side of the magnetic region RA3 is denoted as magnetic region RA4. For example, on the +Y side surface of the permanent magnet 91a, if the magnetic region RA1 corresponds to the S pole, the magnetic region RA2 may be arranged to correspond to the N pole, the magnetic region RA3 to the N pole, and the magnetic region RA4 to the S pole.

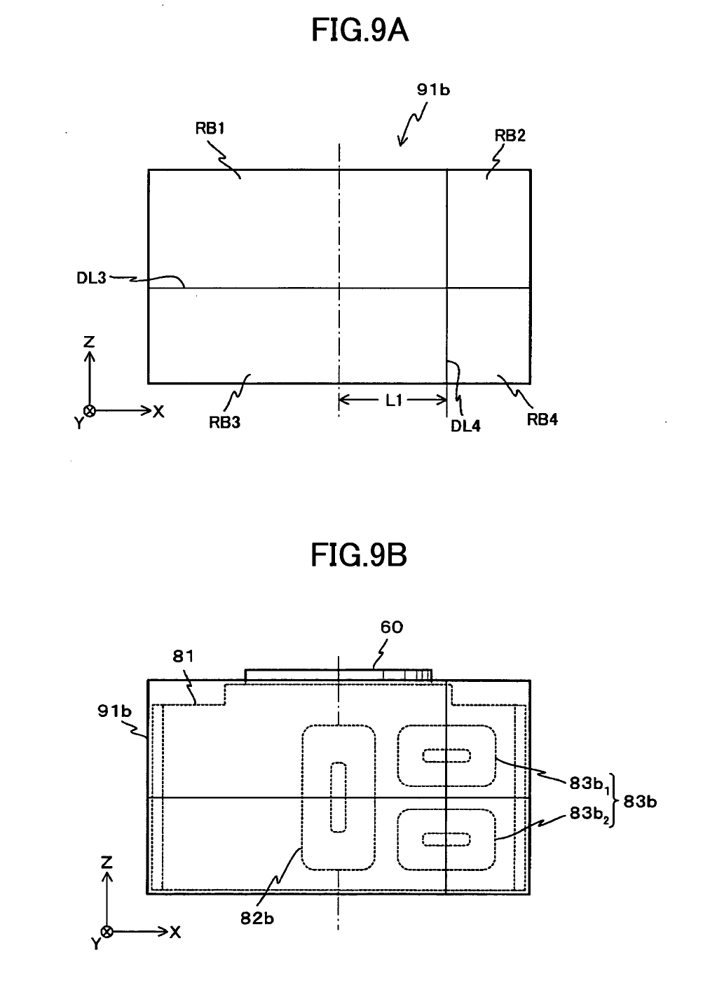

FIGS. 9A and 9B are diagrams illustrating a configuration of the permanent magnet 91b.

As is shown in FIG. 9A, the permanent magnet 91b may be divided into four regions by a magnetic boundary DL3 that is parallel to the XY plane, and a magnetic boundary DL4 that is parallel to the YZ plane. As is shown in FIG. 8B, the magnetic boundary DL3 may correspond to a line that passes through the centers of the focusing coil 82b and the tracking coil 83b with respect to the Z-axis direction. The magnetic boundary DL4 may correspond to a line that passes through the center of the tracking coil 83b with respect to the X-axis direction.

In FIG. 9A, the region at the +Z side of the magnetic boundary DL3 and at the −X side of the magnetic boundary DL4 is denoted as magnetic region RB1, the region at the +X side of the magnetic region RB1 is denoted as magnetic region RB2, the region at the −Z side of the magnetic region RB1 is denoted as magnetic region RB3, and the region at the +X side of the magnetic region RB3 is denoted as magnetic region RB4. For example, on the −Y side surface of the permanent magnet 91b, if the magnetic region RB1 corresponds to the S pole, the magnetic region RB2 may be arranged to correspond to the N pole, the magnetic region RB3 to the N pole, and the magnetic region RB4 to the S pole.

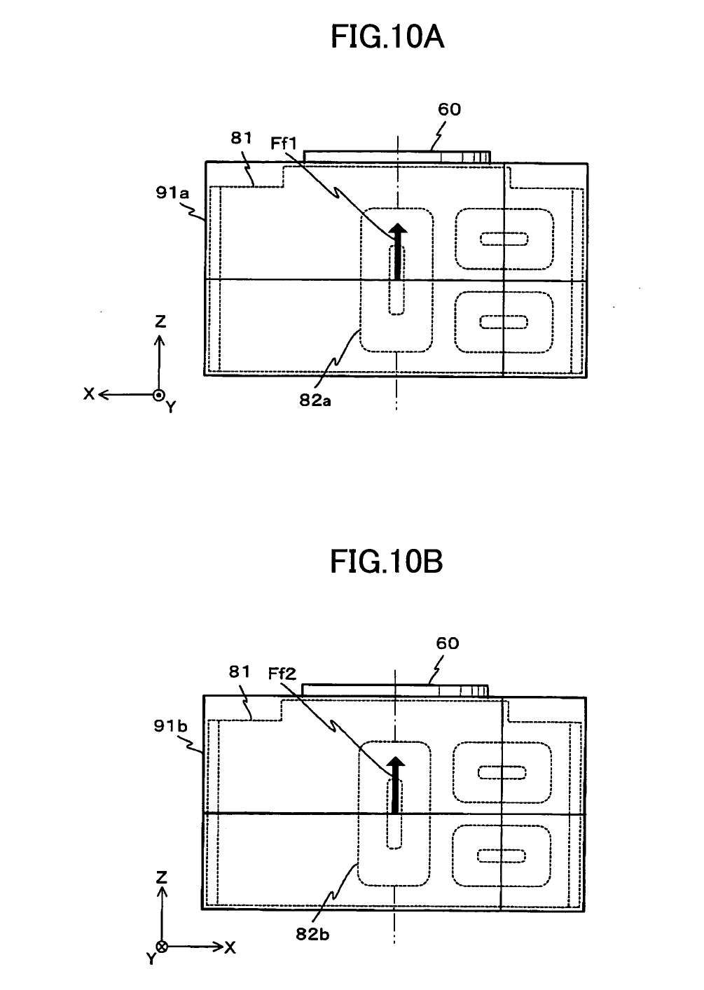

FIGS. 10A and 10B are diagrams illustrating the actions of the focusing coils.

Referring to FIG. 10A, when a drive current is supplied to the focusing coil 82a, a Lorenz force (denoted as Ff1) in the +Z direction (or −Z direction) may be generated with the center of the focusing coil 82a as the working point, based on the electric current flowing within the focusing coil 82a and the magnetic flux from the magnetic regions RA1 and RA3, for example. Referring to FIG. 10B, when a drive current is supplied to the focusing coil 82b, a Lorenz force (Ff2) in the +Z direction (or −Z direction) may be generated with the center of the focusing coil 82b as the working point, based on the electric current flowing within the focusing coil 82b and the magnetic flux from the magnetic regions RB1 and RB3. According to the present example, the Lorenz force Ff1 and the Lorenz force Ff2 may correspond to forces with the same direction. Also, it is noted that the focusing coil 82a and the focusing coil 82b may have substantially identical characteristics, and thereby, the Lorenz force Ff1 and the Lorenz force Ff2 may have substantially the same amount of force. Accordingly, the movable part may be moved in the +Z (or −Z) direction.

It is noted that the amount of force of the Lorenz forces Ff1 and Ff2 may change depending on the amount of current flowing in their corresponding coils. Thereby, the movement of the movable part may be controlled by the amount of drive current. Also, the moving direction (i.e., +Z or −Z direction) of the movable part may be controlled according to the direction of the drive current.

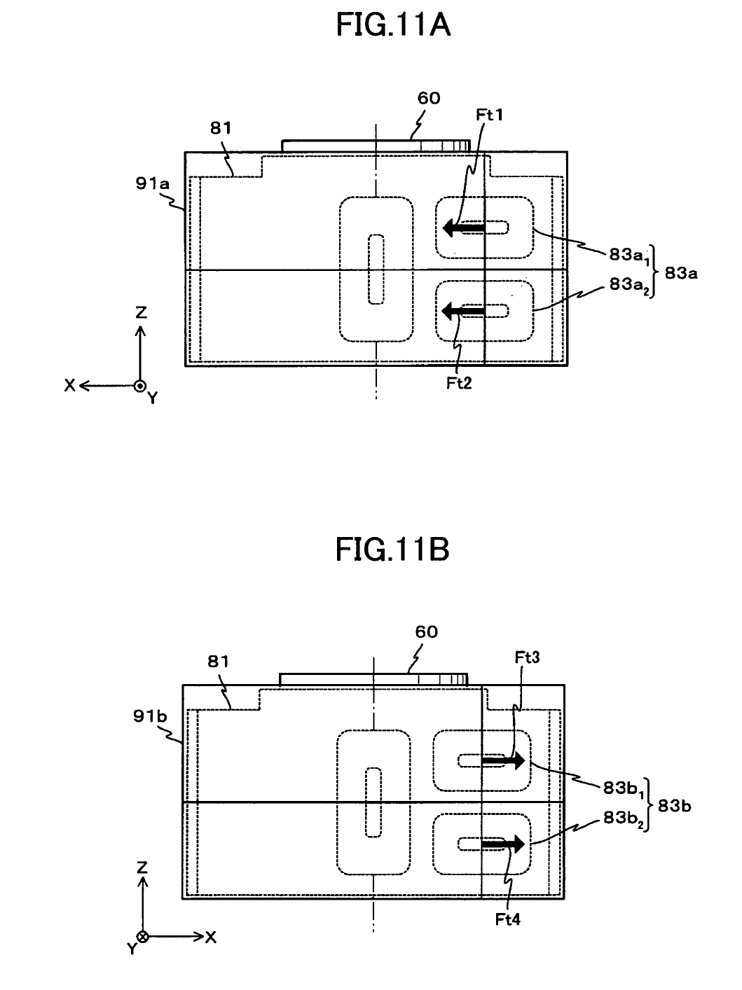

FIGS. 11A and 11B illustrate the actions of the tracking coils 83a and 83b.

Referring to FIG. 11A, when a drive current is supplied to the tracking coil 83a, a Lorenz force (denoted as Ft1) in the +X direction (or −X direction) may be generated with the center of the tracking coil 83a₁ as the working point, based on the electric current flowing within the tracking coil 83a₁ and the magnetic flux from the magnetic regions RA1 and RA2, for example. Also, a Lorenz force (denoted as Ft2) in the +X direction (or −X direction) may be generated with the center of the tracking coil 83a₂ as the working point, based on the electric current flowing within the tracking coil 83a₂ and the magnetic flux from the magnetic regions RA3 and RA4, for example.

Referring to FIG. 11B, when a drive current is supplied to the tracking coil 83b, a Lorenz force (Ft3) in the +X direction (or −X direction) may be generated with the center of the tracking coil 83b₁ as the working point, based on the electric current flowing within the tracking coil 83b₁ and the magnetic flux from the magnetic regions RB1 and RB2. Also, a Lorenz force (Ft4) in the +X direction (or −X direction) may be generated with the center of the tracking coil 83b₂ as the working point, based on the electric current flowing within the tracking coil 83b₂ and the magnetic flux from the magnetic regions RB3 and RB4.

According to the present example, the Lorenz forces Ft1, Ft2, Ft3, and Ft4 may correspond to forces with the same direction. Also, it is noted that the tracking coils 83a₁, 83a₂, 83b₁, and 83b₂ may have substantially identical characteristics, and thereby, the Lorenz forces Ft1, Ft2, Ft3, and Ft4 may have substantially the same amount of force. Accordingly, the movable part may be moved in the +Z (or −Z) direction.

It is also noted that the amount of force of the Lorenz forces Ft1, Ft2, Ft3, and Ft4 may change depending on the amount of current flowing in their corresponding coils. Thereby, the movement of the movable part may be controlled by the controlling the amount of drive current. Also, the moving direction (i.e., +Z or −Z direction) of the movable part may be controlled according to the direction of the drive current.

Referring back to FIG. 1, the reproduced signal processing circuit 28 may include an I/V amplifier 28a, a servo signal detection circuit 28b, a wobble signal detection circuit 28c, an RF signal detection circuit 28d, and a decoder 28e, for example.

The I/V amplifier 28a may be arranged to convert signals from the optical receiver 59 into voltage signals, and amplify the signals with a predetermined gain.

The servo signal detection circuit 28b may be arranged to detect a servo signal including a focus error signal and a track error signal, for example, based on an output signal from the I/V amplifier 28a. It is noted that the focus error signal may be detected using the so-called astigmatism method, and the track error signal may be detected using the so-called push-pull pull method or the phase difference method. The servo signal detected by the serve signal detection circuit 28b may be output to the servo control circuit 26.

The wobble signal detection circuit 28c may be arranged to detect a wobble signal based on the output signal from the I/V amplifier 28a. The RF signal detection circuit 28d may be arranged to detect an RF signal based on the output signal from the I/V amplifier 28a. The decoder 28e may be arranged to extract address information and a synchronizing signal from the wobble signal. The extracted address information may then be output to the CPU 40, and the synchronizing signal may be output to the encoder 25. Also, the decoder 28e may be arranged to conduct a decoding process and an error detection process on the RF signal, conduct an error correction process when an error is detected, and store the decoded/corrected signal as reproduced data in the buffer RAM 34 via the buffer manager 37.

The servo control circuit 26 may include a PU control circuit 26a, a seek motor control circuit 26b, and an SP motor control circuit 26c, for example.

The PU control circuit 26a may be arranged to generate a focus control signal for correcting a focus deviation based on a focus error signal. Also, the PU control circuit 26a may be arranged to generate a tracking control signal for correcting a track deviation based on a track error signal. In turn, a drive current may be output to the optical pickup device 23 according to the control signals generated by the PU control circuit 26a.

The seek motor control circuit 26b may be arranged to generate a drive signal for driving the seek motor 21 based on a command from the CPU 40. The drive signal generated by the seek motor control circuit 26b may then be output to the seek motor 21.

The SP motor control circuit 26c may be arranged to generate a drive signal for driving the spindle motor 22 based on a command from the CPU 40. The drive signal generated by the SP motor control circuit 26c may then be output to the spindle motor 22. Also, it is noted that the SP control circuit 26c may be arranged to adjust the drive signal for the spindle motor 22 so that the linear speed (or angular speed) of the spindle motor 22 may be maintained at a designated speed during a reproducing or recording operation.

The buffer RAM 34 may be arranged to temporarily hold data that are to be recorded on the optical disk 15 (recording data) and data reproduced from the optical disk 15 (reproduced data). The buffer manager 37 may be arranged to manage the inputting and outputting of data to/from the buffer RAM 34.

The encoder 25 may be arranged to acquire recording data stored in the buffer RAM 34 via the buffer manager 37 based on a command from the CPU 40, and conduct processes such as data modulation and error correction code attachment to generate a write signal that is to be written on the optical disk 15. The write signal generated by the encoder 25 may then be output to the laser control circuit 24.

The laser control circuit 24 may be arranged to control the laser power of a laser beam irradiated from the semiconductor laser. For example, upon conducting a recording operation, the laser control circuit 24 may generate a drive signal for the semiconductor laser based on the write signal, recording conditions, and light emitting characteristics of the semiconductor laser.

The interface 38 may correspond to a bidirectional communication interface that is connected to a superordinate apparatus 90 such as a personal computer. The interface 38 may conform to conventional interface standards such as the ATAPI (AT Attachment Packet Interface) or the SCSI (Small Computer System Interface) standard, for example. In a reproducing operation, reproduced data that are stored in the buffer RAM 34 may be output to the superordinate apparatus 90 via the interface 38 one sector at a time, for example. In a recording operation, recording data from the superordinate apparatus 90 may be input via the interface 38 and stored in the buffer RAM via the buffer manager 37.

The flash memory 39 may include a program memory area and a data memory area, for example. The program memory area of the flash memory 39 may be arranged to store one or more programs that are described in code that is readable by the CPU 40. The data memory area of the flash memory 39 may be arranged to store information such as recording conditions and light emitting characteristics of the semiconductor laser.

The CPU 40 may be arranged to control operations of the optical disk apparatus 20 based on the programs stored in the program memory area of the flash memory 39, and store data required for the operations control in the RAM 41 of the CPU 40, for example.

In the following, position control operations for the objective lens 60 within the optical disk apparatus 20 are described.

Focus Control

1. The reproduced signal processing circuit 28 may convert an output signal from the optical receiver 59 into a voltage signal at the I/V amplifier 28a, detect a focus error signal at the servo signal detection circuit 28b, and output the detected focus error signal to the servo control circuit 26.

2. The servo control circuit 26 may generate a focus control signal based on the focus error signal at the PU control circuit 26a, and output a focusing drive current corresponding to the generated focus control signal to the optical pickup device 23.

3. At the optical pickup device 23, the focusing drive current from the PU control circuit 26a may be input to a predetermined input terminal of the fixed printed circuit board 93 and supplied to the focusing coils 82a, b via the wire springs 92a₁ and 92a₂, and the movable printed circuit board 89a.

4. When the focusing drive current is supplied to the focusing coils 82a, b, a drive force (thrust) according to the drive current amount and the drive current direction may be generated as is described above, and in turn, the movable part may be moved in the focusing direction. In this way, the objective lens 60 may be shifted in the focusing direction so that focus deviation may be accurately corrected.

Tracking Control

1. The reproduced signal processing circuit 28 may convert an output signal from the optical receiver 59 into a voltage signal at the I/V amplifier 28a, detect a track error signal at the servo signal detection circuit 28b, and output the detected track error signal to the servo control circuit 26.

2. The servo control circuit 26 may generate a tracking control signal based on the track error signal at the PU control circuit 26a, and output a tracking drive current corresponding to the generated tracking control signal to the optical pickup device 23.

3. At the optical pickup device 23, the tracking drive current from the PU control circuit 26a may be input to a predetermined input terminal of the fixed printed circuit board 93 and supplied to the tracking coils 83a, b via the wire springs 92b₁ and 92b₂, and the movable printed circuit board 89b.

4. When the tracking drive current is supplied to the tracking coils 83a, b, a drive force (thrust) according to the drive current amount and the drive current direction may be generated as is described above, and in turn, the movable part may be moved in the tracking direction. In this way, the objective lens 60 may be shifted in the tracking direction so that track deviation may be accurately corrected.

As can be appreciated from the above descriptions, an actuator implemented in an optical pickup device according to the first embodiment of the present invention may be realized by a lens holder, a pair of focusing coils, a pair of tracking coils, a base plate, plural yokes, plural permanent magnets, a fixed block, and plural wire springs.

Also, according to the first embodiment, processes of the optical disk apparatus are realized by a reproduced signal processing circuit, a CPU, and programs executed by the CPU. However, it is noted that the present invention is not limited to such an embodiment, and for example, at least a part of the processes realized by the CPU in the first embodiment may be realized by hardware.

In an optical pickup apparatus according to the first embodiment, a pair of focusing coils (82a and 82b) are provided, a first focusing coil (82a) being positioned at the +Y side of a lens supporting member (lens holder 81), and a second focusing coil (82b) being positioned at the −Y side of the lens supporting member. The positioning of the focusing coils is arranged such that when one of the focusing coils (e.g., 82a) is rotated by 180 degrees with respect to an optical axis of an objective lens (60), the position of the rotated focusing coil (82a) substantially coincides with the position of the other focusing coil (82b), and the focusing coils are positioned at substantially equivalent positions with respect to the X axis direction. In this way, media tilt may be prevented from occurring in a focus control operation. Also, even when there is a certain amount of variation in the Lorenz forces Ff1 and Ff2, the generation of tangential tilt may be prevented owing to the rigidity of the wire springs. Accordingly, the objective lens (60) may be accurately driven. Also, according to the present embodiment, an error tolerance range with respect to the positioning accuracy of the focusing coils may be widened compared to the prior art so that the assembly and inspection process may be simplified. In turn, an optical pickup device capable of forming an accurately-shaped optical spot on the optical disk 15 may be realized without raising manufacturing costs of the device.

Also, the optical pickup device according to the present embodiment includes a pair of tracking coils (83a, 83b), a first tracking coil (83a) being positioned at the +Y side of the lens holder (81), and a second tracking coil (83b) being positioned at the −Y side of the lens holder (81). The first tracking coil (83a) is positioned away from the first focusing coil (82a) by a distance of L1 in the −X direction, and the second tracking coil (83b) is positioned away from the second focusing coil (82b) by the distance L1 in the +X direction. In this way, media tilt may be prevented from occurring in a tracking control operation.

According to the present embodiment, the focusing coils and the tracking coils may not overlap each other, and thereby, the width of the magnetic gap may be reduced. In this way miniaturization of the optical disk apparatus may be realized while maintaining the thrust power and sensitivity in the focusing and tracking control operations. The workability of the assembling process may be improved and higher reliability may be achieved.

Also, according to the present embodiment, the generation of media tilts may be prevented in conducting focusing and tracking control operations, and thereby, the accurately-shaped optical spots may be accurately formed at predetermined positions of an optical disk. In this way, at least an information reproducing operation may be accurately and stably conducted out of information accessing operations including information recording, reproducing and erasing.

It is noted that in the first embodiment, the focusing coils are positioned at substantially equivalent positions with respect to the X-axis direction. However, the present invention is not limited to such an embodiment, and the focusing coils may be positioned apart from each other with respect to the X-axis direction.

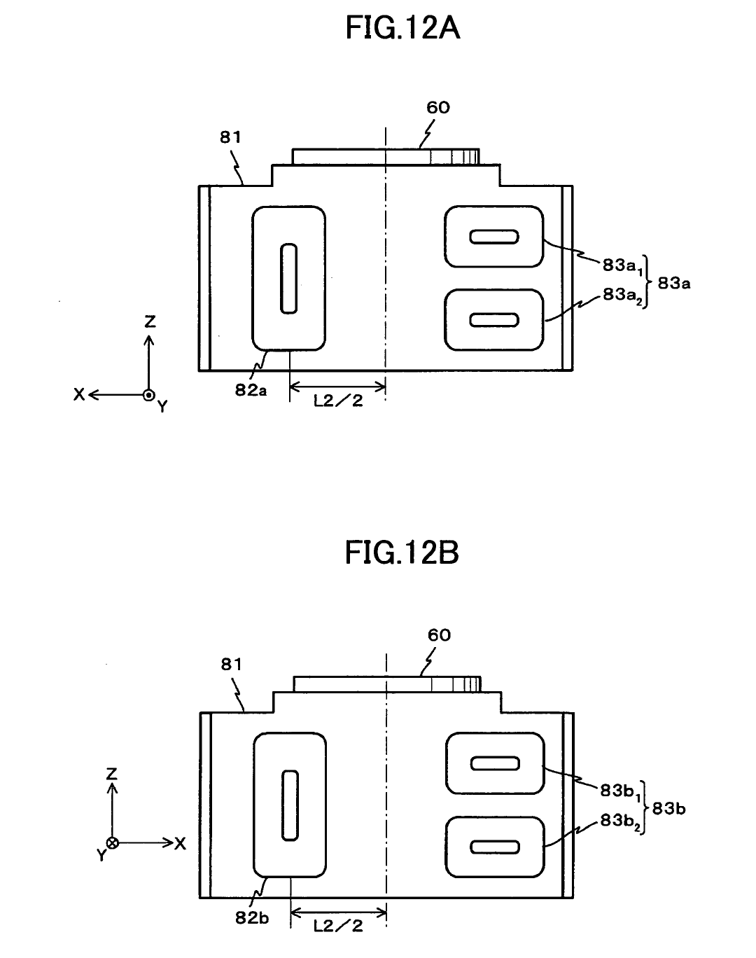

FIGS. 12A and 12B illustrate an example in which the focusing coils are positioned apart from each other with respect to the X axis by a predetermined distance L2. With such an arrangement, greater designing flexibility may be realized. It is noted that the distance L2 is preferably set to a distance that is no greater than the radius of gyration of the movable part. In this way, a tangential tilt may be prevented owing to the rigidity of the wire springs even when there is a certain amount of variation in the Lorenz forces Ff1 and Ff2.

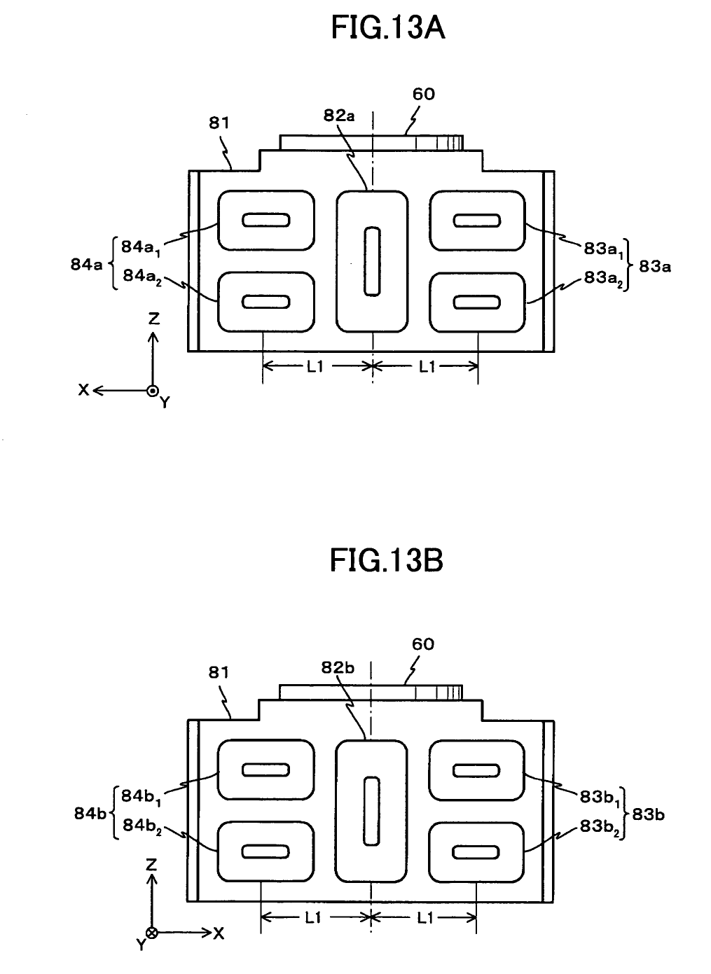

Also, in the illustrated example of the first embodiment, one pair of tracking coils is provided. However, the present invention is not limited to such an embodiment, and for example, plural pairs of tracking coils may be provided as is illustrated in FIGS. 13A and 13B.

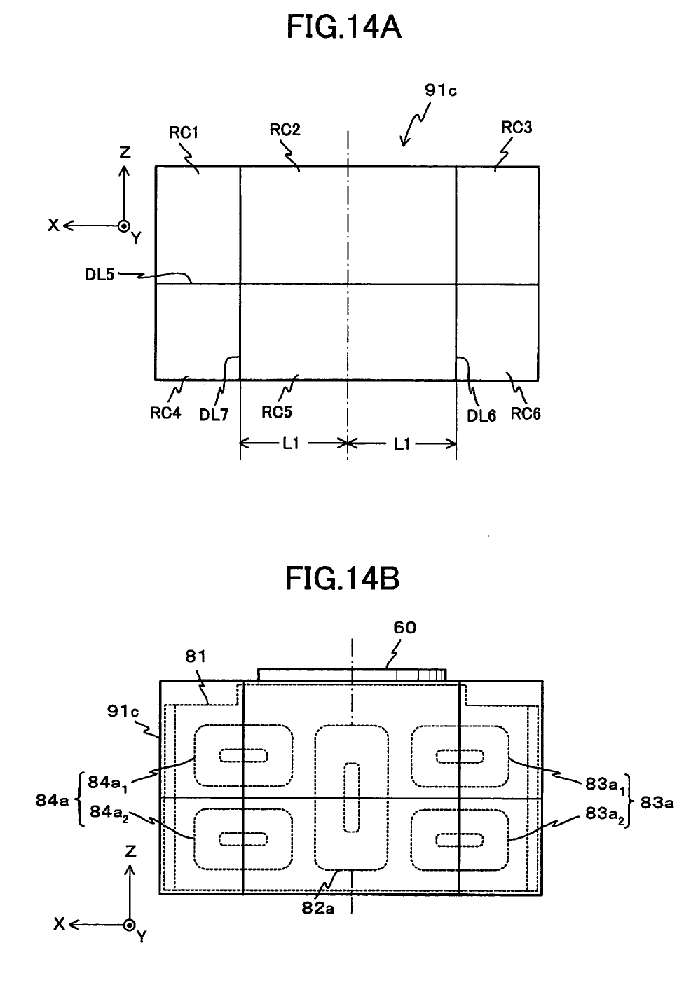

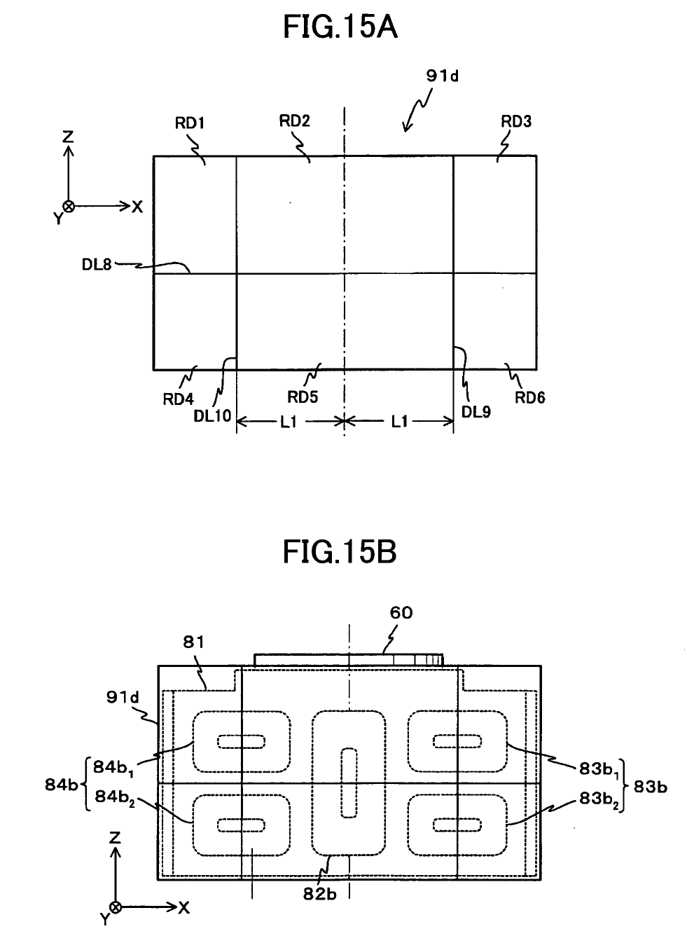

In FIGS. 13A and 13B, two pairs of tracking coils are provided; that is, a second pair of tracking coils 84a and 84b is provided in addition to the pair of tracking coils 83a and 83b. According to the present example, the second pair of tracking coils 84a and 84b is arranged to have substantially the same configuration as the first pair of tracking coils 83a and 83b. The tracking coil 84a (third tracking coil) is positioned away from the focusing coil 82a in the +X direction by a distance L1, and the tracking coil 84b (fourth tracking coil) is positioned away from the focusing coil 82b in the −X direction by the distance L1. It is noted that in the present example, the tracking coil 84a is made up of two coils components 84a₁ and 84a₂, and the tracking coil 84b is made up of two coil components 84b₁ and 84b₂. Also, in the present example, permanent magnets as is illustrated in FIGS. 14A and 14B and FIGS. 15A and 15B may be used.

The permanent magnet 91c shown in FIGS. 14A and 14B may be used instead of the permanent magnet 91a of the first embodiment. As is shown in FIG. 14A, the permanent magnet 91c is divided into six magnetic regions by a magnetic boundary DL5 that is parallel to the XY plane, and magnetic boundaries DL6 and DL7 that are parallel to the YZ plane. As is shown in FIG. 14B, the magnetic boundary DL5 passes through the center of the focusing coil 82a and the tracking coils 84a and 83a with respect to the Z-axis direction. The magnetic boundary DL6 passes through the center of the tracking coil 83a with respect to the X-axis direction, and the magnetic boundary DL7 passes through the center of the tracking coil 84a with respect to the X-axis direction.

In FIG. 14A, a region formed at the +Z side of the magnetic boundary DL5 and at the +X side of the magnetic boundary DL7 is denoted as magnetic region RC1, a region at the −X side of the magnetic region RC1 is denoted as RC2, a region at the −X side of the magnetic region RC2 is denoted as magnetic region RC3, a region at the −Z side of the magnetic region RC1 is denoted as RC4, a region at the −X side of the magnetic region RC4 is denoted as magnetic region RC5, and the region at the −X side of the magnetic region RC5 is denoted as magnetic region RC6. For example, on the +Y side plane of the permanent magnet 91c, if the magnetic region RC1 is arranged to correspond to the S pole, then the magnetic region RC2 corresponds to the N pole, the magnetic region RC3 corresponds to the S pole, the magnetic region RC4 corresponds to the N pole, the magnetic region RC5 corresponds to the S pole, and the magnetic region RC6 corresponds to the N pole.

The permanent magnet 91d shown in FIGS. 15A and 15B may be used instead of the permanent magnet 91b of the first embodiment. As is shown in FIG. 15A, the permanent magnet 91d is divided into six magnetic regions by a magnetic boundary DL8 that is parallel to the XY plane, and magnetic boundaries DL9 and DL10 that are parallel to the YZ plane. As is shown in FIG. 15B, the magnetic boundary DL8 passes through the center of the focusing coil 82b and the tracking coils 84b and 83b with respect to the Z-axis direction. The magnetic boundary DL9 passes through the center of the tracking coil 83b with respect to the X-axis direction, and the magnetic boundary DL10 passes through the center of the tracking coil 84b with respect to the X-axis direction.

In FIG. 15A, a region formed at the +Z side of the magnetic boundary DL8 and at the −X side of the magnetic boundary DL10 is denoted as magnetic region RD1, a region at the +X side of the magnetic region RD1 is denoted as RD2, a region at the +X side of the magnetic region RD2 is denoted as magnetic region RD3, a region at the −Z side of the magnetic region RD1 is denoted as RD4, a region at the +X side of the magnetic region RD4 is denoted as magnetic region RD5, and the region at the +X side of the magnetic region RD5 is denoted as magnetic region RD6. For example, on the −Y side plane of the permanent magnet 91d, if the magnetic region RD1 is arranged to correspond to the S pole, then the magnetic region RD2 corresponds to the N pole, the magnetic region RD3 corresponds to the S pole, the magnetic region RD4 corresponds to the N pole, the magnetic region RD5 corresponds to the S pole, and the magnetic region RD6 corresponds to the N pole.

According to the present example, when a drive current is supplied to the focusing coil 82a, a Lorenz force (denoted as Ff3) in the +Z direction (or −Z direction) may be generated with the center of the focusing coil 82a as the working point, based on the electric current flowing within the focusing coil 82a and the magnetic flux from the magnetic regions RC2 and RC5. When a drive current is supplied to the focusing coil 82b, a Lorenz force (Ff4) in the +Z direction (or −Z direction) may be generated with the center of the focusing coil 82b as the working point, based on the electric current flowing within the focusing coil 82b and the magnetic flux from the magnetic regions RD2 and RD5. It is noted that the Lorenz force Ff3 and the Lorenz force Ff4 may correspond to forces with the same direction. Also, it is noted that the focusing coil 82a and the focusing coil 82b may have substantially identical characteristics, and thereby, the Lorenz force Ff3 and the Lorenz force Ff4 may have substantially the same amount of force. Accordingly, the movable part may be moved in the +Z (or −Z) direction.

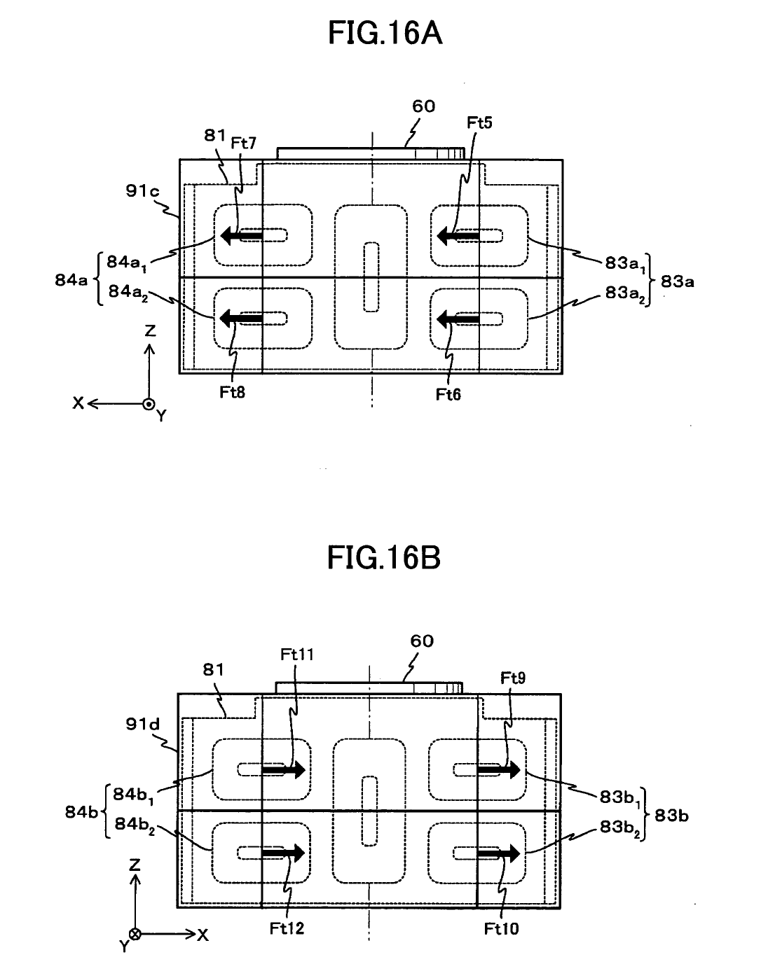

FIGS. 16A and 16B are diagrams illustrating the actions of the two pairs of tracking coils 83a and 83b, and 84a and 84b.

Referring to FIG. 16A, when a drive current is supplied to the tracking coil 83a, a Lorenz force (denoted as Ft5) in the +X direction (or −X direction) may be generated with the center of the tracking coil 83a₁ as the working point, based on the electric current flowing within the tracking coil 83a₁ and the magnetic flux from the magnetic regions RC2 and RC3, for example. Also, a Lorenz force (denoted as Ft6) in the +X direction (or −X direction) may be generated with the center of the tracking coil 83a₂ as the working point, based on the electric current flowing within the tracking coil 83a₂ and the magnetic flux from the magnetic regions RC5 and RC6, for example.

When a drive current is supplied to the tracking coil 84a, a Lorenz force (denoted as Ft7) in the +X direction (or −X direction) may be generated with the center of the tracking coil 84a₁ as the working point, based on the electric current flowing within the tracking coil 84a₁ and the magnetic flux from the magnetic regions RC1 and RC2, for example. Also, a Lorenz force (denoted as Ft8) in the +X direction (or −X direction) may be generated with the center of the tracking coil 84a₂ as the working point, based on the electric current flowing within the tracking coil 84a₂ and the magnetic flux from the magnetic regions RC4 and RC5, for example.

Referring to FIG. 16B, when a drive current is supplied to the tracking coil 83b, a Lorenz force (Ft9) in the +X direction (or −X direction) may be generated with the center of the tracking coil 83b₁ as the working point, based on the electric current flowing within the tracking coil 83b₁ and the magnetic flux from the magnetic regions RD2 and RD3. Also, a Lorenz force (Ft10) in the +X direction (or −X direction) may be generated with the center of the tracking coil 83b₂ as the working point, based on the electric current flowing within the tracking coil 83b₂ and the magnetic flux from the magnetic regions RD5 and RD6.

When a drive current is supplied to the tracking coil 84b, a Lorenz force (Ft11) in the +X direction (or −X direction) may be generated with the center of the tracking coil 84b₁ as the working point, based on the electric current flowing within the tracking coil 84b₁ and the magnetic flux from the magnetic regions RD1 and RD2. Also, a Lorenz force (Ft12) in the +X direction (or −X direction) may be generated with the center of the tracking coil 84b₂ as the working point, based on the electric current flowing within the tracking coil 84b₂ and the magnetic flux from the magnetic regions RD4 and RD5.

According to the present example, the Lorenz forces Ft5˜Ft12 may correspond to forces with the same direction. Also, it is noted that the tracking coils 83a₁, 83a₂, 83b₁, 83b₂, 84a₁, 84a₂, 84b₁, and 84b₂ may have substantially identical characteristics, and thereby, the Lorenz forces Ft5˜Ft12 may have substantially the same amount of force. In this way, the movable part may be moved in the +Z (or −Z) direction.

### Second Embodiment

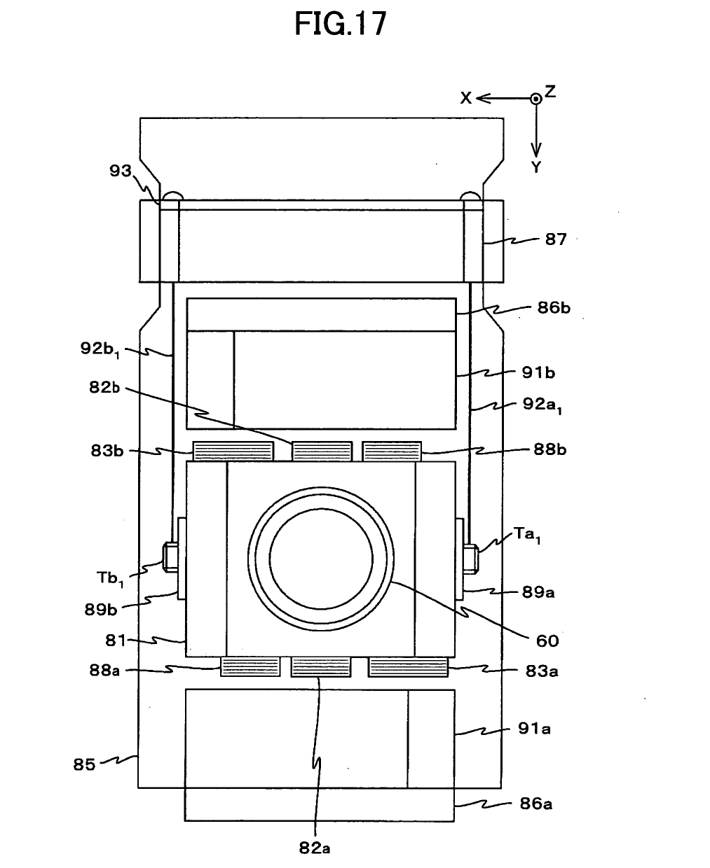

In the following, a second embodiment of the present invention is described with reference to FIGS. 17˜21B.

FIG. 17 shows an exemplary configuration of an optical pickup device according to the second embodiment of the present invention. The optical pickup of FIG. 17 includes a pair of tilt coils 88a and 88b that are arranged to generate torque rotating around an axis corresponding to the tangential direction in addition to the elements of the optical pickup device according to the first embodiment. In other words, the optical pickup device according to the second embodiment corresponds to a so-called three-axis optical pickup device. In the following, features of the second embodiment that are different from those of the first embodiment are mainly described. It is noted that elements of the present embodiment that are identical or equivalent to those of the first embodiment are assigned the same numerical references and their descriptions may be simplified or omitted.

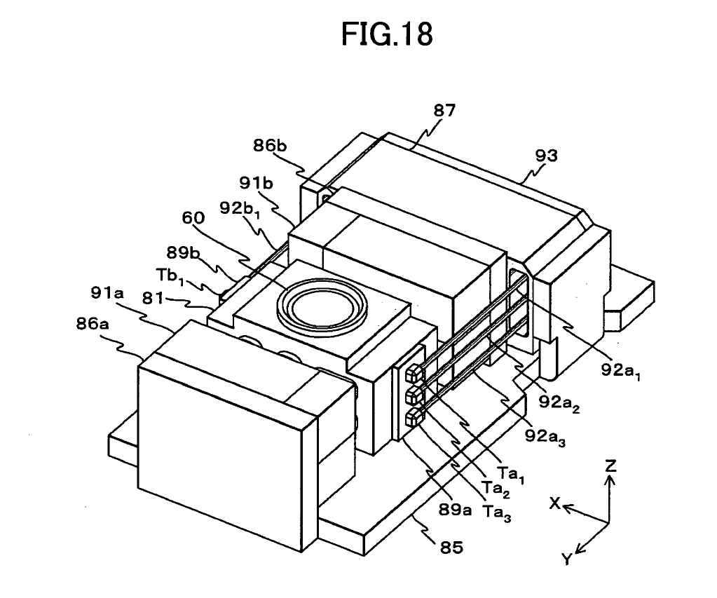

FIG. 18 is a perspective view of the optical pickup device of FIG. 17. As is shown in this drawing, the optical pickup device may include two wire springs 92a₃ and 92b₃ for supplying power to the tilt coils 88a and 88b in addition to the four wire springs 92a₁, 92b₁, 92a₂, and 92b₂ provided in the first embodiment.

Also, according to the present example, the movable printed circuit board 89a includes three terminals Ta₁, Ta₂, and Ta₃, and the movable printed circuit board 89b includes three terminals Tb₁, Tb₂, and Tb₃. The terminal Ta₁ is connected to one end of the wire spring 92a₁, the terminal Ta₂ is connected to one end of the wire spring 92a₂, and the terminal Ta₃ is connected to one end of the wire spring 92a₃. The terminal Tb₁ is connected to one end of the wire spring 92b₂, the terminal Tb₂ is connected to one end of the wire spring 92b₂, and the terminal Tb₃ is connected to one end of the wire spring 92b₃. The other ends of the wire springs 92a₁, 92b₁, 92a₂, 92b₂, 92a₃, and 92b₃ are connected to output terminals of the fixed printed circuit board 93 via through holes provided at the fixed block 87, the connection being realized through soldering, for example.

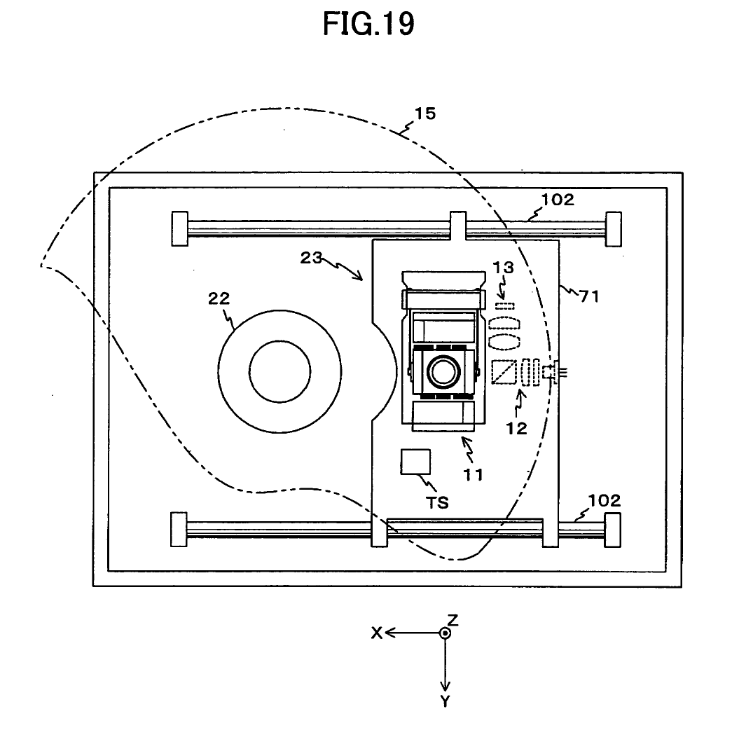

In one example, as is shown in FIG. 19, a tilt sensor TS for measuring a radial tilt may be provided on the housing 71.

A measurement result of the tilt sensor TS may be supplied to the servo signal detection circuit 28b via the I/V amplifier 28a. In turn, the servo signal detection circuit 28b may detect a tilt signal corresponding to the radial tilt based on the output signal of the tilt sensor TS, and output the detected signal to the PU control circuit 26a.

The PU control circuit 26a may generate a tilt control signal for correcting the radial tilt based on the tilt signal. In turn, a drive current corresponding to the tilt control signal may be output to the PU control circuit 26a.

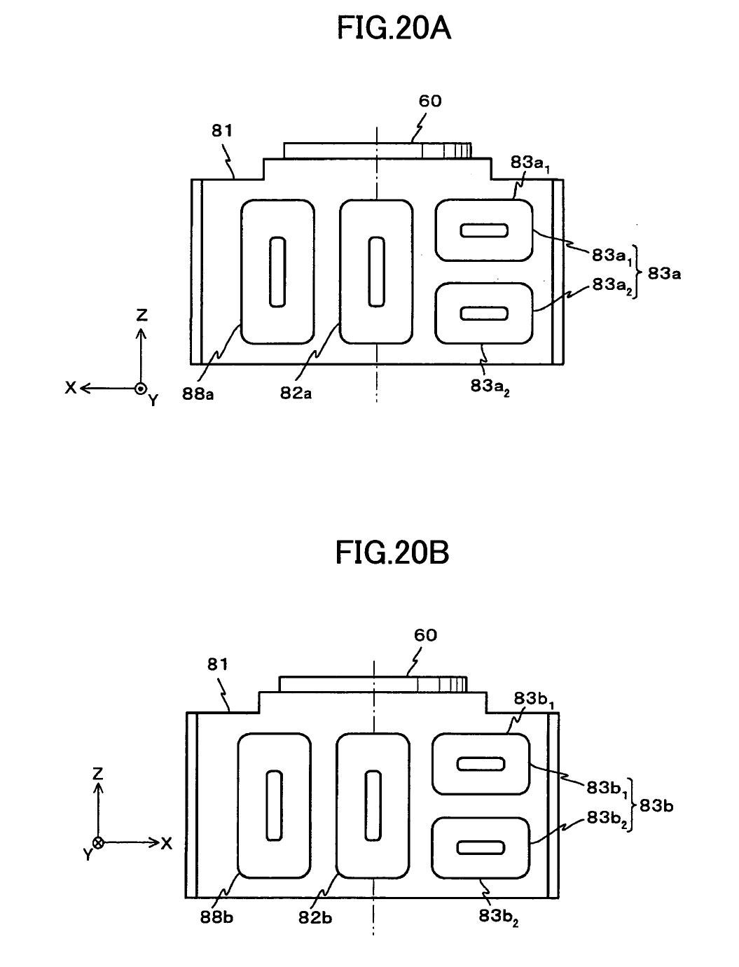

FIGS. 20A and 20B are diagrams illustrating an exemplary positioning of the tilt coils 88a (first tilt coil) and 88b (second tilt coil). As is shown in the drawings, the tilt coil 88a (first tilt coil) may be positioned at the +X side of the focusing coil 82a (first focusing coil), and the tilt coil 88b (second tilt coil) may be positioned at the −X side of the focusing coil 82b (second focusing coil). It is noted that the tilt coils may have configurations that are substantially identical to those of the focusing coils.

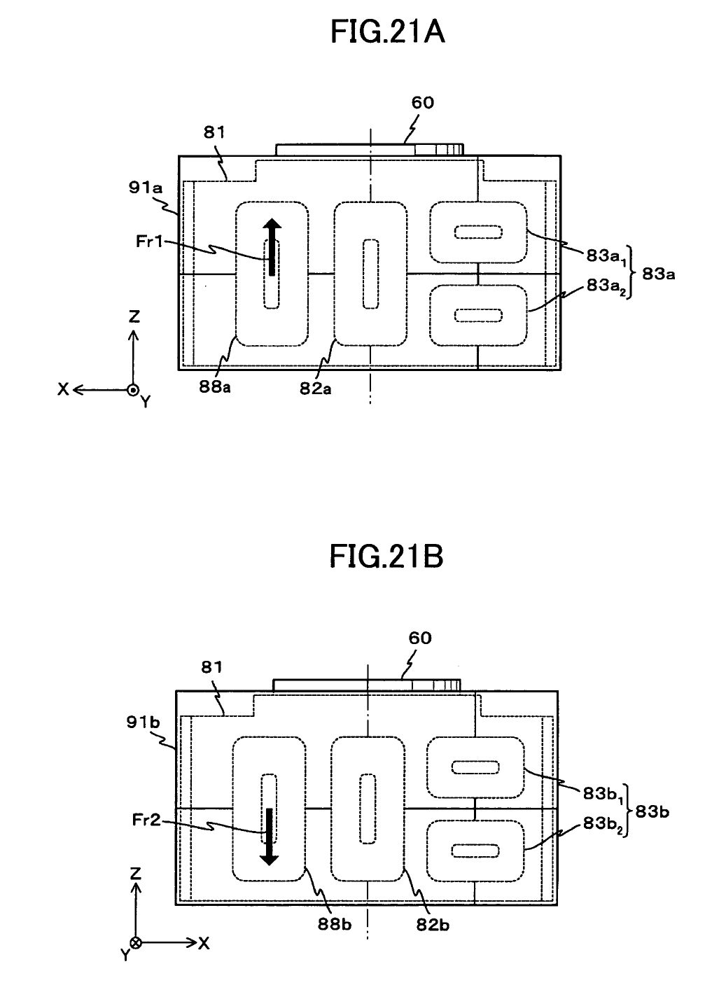

FIGS. 21A and 21B are diagrams illustrating exemplary actions of the tilt coils 88a and 88b.

Referring to FIG. 21A, when a drive current is supplied to the tilt coil 88a, a Lorenz force (denoted as Fr1) in the +Z direction (or −Z direction) may be generated with the center of the tilt coil 88a as the working point, based on the electric current flowing within the tilt coil 88a and the magnetic flux from the magnetic regions RA1 and RA3. Referring to FIG. 21B, when a drive current is supplied to the focusing coil 88b, a Lorenz force (Fr2) in the −Z direction (or +Z direction) may be generated with the center of the tilt coil 88b as the working point, based on the electric current flowing within the focusing coil 88b and the magnetic flux from the magnetic regions RB1 and RB3. According to the present example, the Lorenz force Fr1 and the Lorenz force Fr2 may correspond to forces with opposite directions with respect to each other. Also, it is noted that the focusing coil 82a and the focusing coil 82b may have substantially identical characteristics, and thereby, the Lorenz force Ff1 and the Lorenz force Ff2 may have substantially the same amount of force. In this way, torque rotating around an axis corresponding to the tangential direction may be generated.

It is noted that the amount of force of the Lorenz forces Fr1 and Fr2 may change depending on the amount of current flowing in their corresponding coils. Thereby, the movement of the movable part may be controlled by the amount of drive current. Also, the rotating direction of the movable part may be controlled according to the direction of the drive current.

In the following, a control operation for controlling a radial tilt in the optical disk apparatus 20 is described.

1. The reproduced signal processing circuit 28 may convert an output signal from the tilt sensor TS into a voltage signal at the I/V amplifier 28a, detect a tilt signal at the servo signal detection circuit 28b, and output the detected tilt signal to the servo control circuit 26.

2. The servo control circuit 26 may generate a tilt control signal based on the tilt signal at the PU control circuit 26a, and output a tilting drive current corresponding to the generated tilt control signal to the optical pickup device 23.

3. At the optical pickup device 23, the tilting drive current from the PU control circuit 26a may be input to a predetermined input terminal of the fixed printed circuit board 93 and supplied to the tilt coils via the wire springs 92a₃ and 92b₃, and the movable printed circuit boards 89a and 89b.

4. When the tilting drive current is supplied to the tilt coils, torque according to the drive current amount and the drive current direction may be generated as is described above, and in turn, the movable part may be rotated around an axis corresponding to the tangential direction. In this way, the objective lens 60 may be moved so that radial tilt may be accurately corrected.

As can be appreciated from the above descriptions, the optical pickup device according to the second embodiment includes a pair of tilt coils for generating torque rotating around an axis corresponding to the tangential direction, and thereby, active control of the radial tilt in the optical disk apparatus may be realized in addition to the effects and advantages of the first embodiment.

Also, according to an embodiment, the tracking coil 83a (first tracking coil) and the tilt coil 84a (first tilt coil) are positioned at the −X side and +X side, respectively, of the focusing coil 82a (first focusing coil), and the tracking coil 83b (second tracking coil) and the tilt coil 84b (second tilt coil) are positioned at the −X side and +X side, respectively, of the focusing coil 82b (second focusing coil). In this case, the tracking coils, the focusing coils, and the tilt coils do not overlap with one another, and thereby the width of the magnetic gap may be reduced. In this way, miniaturization of the optical pickup device may be realized while maintaining the thrust force and sensitivity of the focus control, tracking control, and tilt control. Also, workability of the assembling process may be improved so that higher reliability may be achieved.

According to an embodiment, the tilt coils may be arranged to have the same configuration as the focusing coils, and thereby, cost reduction may be realized.

Also, in the optical disk apparatus according to the second embodiment, media tilts may be prevented from being generated upon conducting focus control and tracking control, and radial tilt in the optical disk may be accurately corrected so that an accurately-shaped optical spot may be accurately formed at a predetermined position on the optical disk. In this way, at least an information reproducing operation may be accurately and stably conducted out of information accessing operations including information recording, reproducing and erasing.

It is noted that in the illustrated optical pickup device according to the second embodiment, six wire springs are provided. However, the present invention is not limited to such a case. For example, four wire springs and two twisted wires may be used for realizing power supply instead of using six wire springs.

It is also noted that, in the illustrated configuration of the second embodiment, the radial tilt is determined by the tilt sensor TS. However, the present invention is not limited to such a case. For example, the radial tilt may be estimated from the RF signal, and in such a case the tilt sensor may not be required.

Also, the tilt coils and the focusing coils are arranged to have identical configurations in the illustrated example. However, the present invention is not limited to such an example.

It is noted that in the embodiments described above, wire springs are used to elastically support the movable part. However, the present invention is not limited to such a case, and for example, leaf springs may be used instead of the wire springs.

Also, in the embodiments described above, the wire springs are arranged to be conductive; however, the present invention is not limited to such a case. Further, in the embodiments described above, the connection between the wire springs and the printed circuit boards are realized through soldering. However, the connection may equally be realized through bonding or insert molding, for example. It is noted that in such cases, separate wiring may be needed to provide power to the coils.

Also, in the embodiments described above, the information recording medium being used corresponds to an optical disk conforming to the DVD standard. However, the present invention is not limited to such a case, and for example, an optical disk conforming to the CD standard or a future generation information recording medium adapted for a light flux with a wavelength of approximately 405 nm may be used.

Also, in the embodiments described above, one light source is provided in the optical disk apparatus; however, the present invention is not limited to such a case. For example, plural light sources including at least one of a light source for irradiating a light flux with a wavelength of approximately 405 nm, a light source for irradiating a light flux with a wavelength of approximately 660 nm, and a light source for irradiating a light flux with a wavelength of approximately 780 nm may be provided in the optical disk apparatus.

Also, it is noted that in the embodiments described above, the optical disk apparatus is arranged to be capable of information recording and reproduction. However, the application of the present invention is not limited to such an optical disk apparatus. Rather, the present invention may be applicable to other various optical disk apparatuses that are at least capable of conducting an information reproducing operation out of information accessing operations including information recording, reproducing and erasing.

The present application is based on and claims the benefit of the earlier filing date of Japanese Patent Application No.2004-046365 filed on Feb. 23, 2004, the entire contents of which are hereby incorporated by reference.

1. An actuator that is configured to drive an objective lens that condenses light on a recording surface of an optical disk having a spiral track or concentric tracks formed thereon, the actuator comprising:
a pair of focusing coils, a positioning of which focusing coils is arranged such that if a first focusing coil of the focusing coils is rotated by 180 degrees around an optical axis of the objective lens, a resulting position of the first focusing coil after the rotation substantially coincides with a position of a second focusing coil of the focusing coils, the pair of focusing coils being configured to generate a thrust force in a direction along the optical axis of the objective lens according to a current supplied thereto; and
a lens supporting member that supports the objective lens, the first focusing coil being fixed at one side of the lens supporting member with respect to a tangential direction of the track, and the second focusing coil being fixed at the other side of the lens supporting member with respect to the tangential direction of the track.

2. The actuator as claimed in claim 1, further comprising:
at least a pair of tracking coils that is fixed to the lens supporting member and is configured to generate a thrust force in a tracking direction that is perpendicular to the tangential direction of the track according to a current supplied thereto.

3. The actuator as claimed in claim 2, wherein the first focusing coil and the second focusing coil are arranged at substantially equivalent positions with respect to the tracking direction.

4. The actuator as claimed in claim 2, wherein the first focusing coil and the second focusing coil are positioned apart from each other by a predetermined distance with respect to the tracking direction.

5. The actuator as claimed in claim 4, wherein the predetermined distance is less than or equal to a radius of gyration of a movable part that includes the objective lens, the lens supporting member, the first and second focusing coils, and the tracking coils.

6. The actuator as claimed in claim 2, wherein the at least one pair of tracking coils is arranged to have a predetermined positional relation with respect to the pair of focusing coils.

7. The actuator as claimed in claim 6, wherein
the at least one pair of tracking coils includes a first tracking coil and a second tracking coil;
the first tracking coil being positioned at one side of the first focusing coil with respect to the tracking direction, the second tracking coil being positioned at the other side of the second tracking coil with respect to the tracking direction.

8. The actuator as claimed in claim 6, wherein
the at least one pair of tracking coils includes a first pair of tracking coils formed by a first tracking coil and a second tracking coil, and a second pair of tracking coils formed by a third tracking coil and a fourth tracking coil,
the first tracking coil being positioned at one side and the third tracking coil being positioned at the other side of the first focusing coil with respect to the tracking direction, and the fourth tracking coil being positioned at the one side and the second tracking coil being positioned at the other side of the second focusing coil with respect to the tracking direction.

9. The actuator as claimed in claim 2, further comprising:
a pair of tilt coils that is fixed to the lens supporting member and is configured to generate torque that rotates around an axis corresponding to the tangential direction of the track according to a current supplied thereto.

10. The actuator as claimed in claim 9, wherein the pair of focusing coils, the pair of tracking coils, and the pair of tilt coils are arranged to have a predetermined positional relation with respect to each other.

11. The actuator as claimed in claim 9, wherein
the pair of tracking coils includes a first tracking coil and a second tracking coil; and
the pair of tilt coils includes a first tilt coil and a second tilt coil;
the first tracking coil being positioned at one side and the first tilt coil being positioned at the other side of the first focusing coil with respect to the tracking direction, and the second tilt coil being positioned on the one side and the second tracking coil being positioned on the other side of the second focusing coil with respect to the tracking direction.

12. The actuator as claimed in claim 9, wherein the tilt coils are arranged to have a same configuration as the focusing coils.

13. An optical pickup device that is configured to irradiate light on a recording surface of an optical disk having a spiral track or concentric tracks formed thereon and receive reflected light that is reflected from the recording surface, the device comprising:
an actuator that is configured to drive an objective lens that condenses light on the recording surface which actuator includes
a pair of focusing coils, a positioning of which focusing coils is arranged such that if a first focusing coil of the focusing coils is rotated by 180 degrees around an optical axis of the objective lens, a resulting position of the first focusing coil after the rotation substantially coincides with a position of a second focusing coil of the focusing coils, the pair of focusing coils being configured to generate a thrust force in a direction along the optical axis of the objective lens according to a current supplied thereto; and
a lens supporting member that supports the objective lens, the first focusing coil being fixed at one side of the lens supporting member with respect to a tangential direction of the track, and the second focusing coil being fixed at the other side of the lens supporting member with respect to the tangential direction of the track;
a light source that is configured to emit a light flux to be irradiated on the recording surface;
an optical system including the objective lens that condenses the light flux from the light source onto the recording surface, the optical system being configured to guide the reflected light reflected from the recording surface to a predetermined light receiving position;
an optical detector that is positioned at the light receiving position; and
a tilt detecting unit that is configured to detect a tilting of the recording surface with respect to the objective lens.

14. An optical pickup device that is configured to irradiate light on a recording surface of an optical disk having a spiral track or concentric tracks formed thereon and receive reflected light that is reflected from the recording surface, the device comprising:
an actuator that is configured to drive an objective lens that condenses light on the recording surface which actuator includes
a pair of focusing coils, a positioning of which focusing coils is arranged such that if a first focusing coil of the focusing coils is rotated by 180 degrees around an optical axis of the objective lens, a resulting position of the first focusing coil after the rotation substantially coincides with a position of a second focusing coil of the focusing coils, the pair of focusing coils being configured to generate a thrust force in a direction along the optical axis of the objective lens according to a current supplied thereto;
a lens supporting member that supports the objective lens, the first focusing coil being fixed at one side of the lens supporting member with respect to a tangential direction of the track, and the second focusing coil being fixed at the other side of the lens supporting member with respect to the tangential direction of the track;
at least a pair of tracking coils that is fixed to the lens supporting member and is configured to generate a thrust force in a tracking direction that is perpendicular to the tangential direction of the track according to a current supplied thereto; and
a pair of tilt coils that is fixed to the lens supporting member and is configured to generate torque that rotates around an axis corresponding to the tangential direction of the track according to a current supplied thereto;
a light source that is configured to emit a light flux to be irradiated on the recording surface;
an optical system including the objective lens that condenses the light flux from the light source onto the recording surface, the optical system being configured to guide the reflected light reflected from the recording surface to a predetermined light receiving position;
an optical detector that is positioned at the light receiving position; and
a tilt detecting unit that is configured to detect a tilting of the recording surface with respect to the objective lens.

15. An optical disk apparatus that is configured to conduct an information accessing operation including at least an information reproducing operation on an optical disk, the apparatus comprising:
an optical pickup device that is configured to irradiate light on a recording surface of an optical disk having a spiral track or concentric tracks formed thereon and receive reflected light that is reflected from the recording surface, the device including
an actuator that is configured to drive an objective lens that condenses light on the recording surface which actuator includes
a pair of focusing coils, a positioning of which focusing coils is arranged such that if a first focusing coil of the focusing coils is rotated by 180 degrees around an optical axis of the objective lens, a resulting position of the first focusing coil after the rotation substantially coincides with a position of a second focusing coil of the focusing coils, the pair of focusing coils being configured to generate a thrust force in a direction along the optical axis of the objective lens according to a current supplied thereto; and
a lens supporting member that supports the objective lens, the first focusing coil being fixed at one side of the lens supporting member with respect to a tangential direction of the track, and the second focusing coil being fixed at the other side of the lens supporting member with respect to the tangential direction of the track;
a light source that is configured to emit a light flux to be irradiated on the recording surface;
an optical system including the objective lens that condenses the light flux from the light source onto the recording surface, the optical system being configured to guide the reflected light reflected from the recording surface to a predetermined light receiving position;
an optical detector that is positioned at the light receiving position; and
a tilt detecting unit that is configured to detect a tilt of the recording surface with respect to the objective lens; and
a processing unit that is configured to control the actuator of the optical pickup device based on an output signal of the optical pickup device and execute the information accessing operation.
